(19) United States
(12) Patent Application Publication
(10) Pub. No.: US 2024/0295140 A1
(43) Pub. Date: Sep. 5, 2024

(54) DOOR LOCKING MECHANISM DETERMINATION AND VERIFICATION SYSTEM AND METHOD

(71) Applicant: Transportation IP Holdings, LLC, Norwalk, CT (US)

(72) Inventors: Nathan Sowie, Buffalo Grove, IL (US); Afsar Ali, Buffalo Grove, IL (US); Karl J. Kobel, Wildwood, IL (US); Peter Heidrich, Buffalo Grove, IL (US)

(21) Appl. No.: 18/405,057

(22) Filed: Jan. 5, 2024

Related U.S. Application Data
(60) Provisional application No. 63/449,885, filed on Mar. 3, 2023.

(51) Int. Cl. E05B 81/74; E05B 81/16; E05B 81/62

(52) U.S. Cl. CPC E05B 81/74; E05B 81/16; E05B 81/62

(57) ABSTRACT

A system is provided that may include a motor, a locking mechanism, an encoder, and a controller. The motor may rotate a shaft to move a door between an open position and a closed position. The locking mechanism may alternate between a locked and an unlocked position. The locking mechanism may retain the door in the closed position responsive to the locking mechanism being in the locked position and may allow the door to move to the open position responsive to the locking mechanism being in the unlocked position. The encoder may be coupled with the motor and may determine one or more of movement, a speed, or a direction the motor moves. The controller may receive output from the encoder indicative of the one or more of the movement, the speed, or the direction the motor moves to determine a position of the locking mechanism.

### CROSS-REFERENCE TO RELATED APPLICATIONS

This application claims priority to U.S. Provisional Application No. 63/449,885 (filed 3 Mar. 2023), the entire disclosure of which is incorporated herein by reference.

### BACKGROUND

### Technical Field

The present disclosure relates generally to systems and methods for sensing and verifying the position of a locking mechanism for a door system.

### Discussion of Art

Systems equipped with doors, such as vehicles or buildings, may need a system or method to ensure that the doors are closed and locked, and will remain closed and locked until unlocked. Doors may have various locking mechanisms to ensure the door remains closed and locked until unlocked.

In some doors or door systems, an overcenter locking mechanism may be used to lock the door. The overcenter locking mechanism may be a mechanical lock that may use linkages where a central joint passes through a center line between end joints from one side where the joints can freely move and allow a force from held objects to rotate the joints and the objects to come together to a stopped position where the forces moving the held objects together forces the linkages further against a stop.

In existing systems using an overcenter locking mechanism, a primary sensor (such as a switch, a proximity sensor, or the like) may be used to determine whether the doors are closed and the overcenter locking mechanism is locked. The primary sensor may be referred to as a door lock (DL) sensor. The DL sensor may change state when the doors reach the end of their travel or when the overcenter locking mechanism may be in the locked position.

An issue with using a sensor to determine the state of the door and the locking mechanism is that the sensor may fail or malfunction. When the sensor lock validation fails, there may not be another way to determine if the doors are closed and the locking mechanism is locked. This may result in a dangerous situation for the passengers of the vehicle or vehicle system, as the doors could open without the sensor determining the doors are open or opening. Therefore, it may be useful to determine and/or validate the status of the doors and the locking mechanism that may be independent of the primary sensor. Additionally, it may be advantageous to determine and/or validate the status of the doors and the locking mechanism using existing components and without adding additional components to the system. Additional components may result in added cost and complexity to the system.

It may be desirable to have a system and method that differs from those that are currently available.

### BRIEF DESCRIPTION

In one embodiment, a system may include a motor, a locking mechanism, an encoder, and a controller. The motor may rotate a shaft to move a door between an open position and a closed position. The locking mechanism may alternate between a locked position and an unlocked position. The locking mechanism may retain the door in the closed position responsive to the locking mechanism being in the locked position. The locking mechanism may allow the door to move to the open position responsive to the locking mechanism being in the unlocked position. The encoder may be coupled with the motor and may determine one or more of movement, a speed, or a direction the motor moves. The controller may receive output from the encoder indicative of the one or more of the movement, the speed, or the direction the motor moves to determine a position of the locking mechanism.

In one embodiment, a system is provided that may include a motor, a locking mechanism, one or more sensors, an encoder, and a controller. The motor may rotate a shaft to move a door between an open position and a closed position. The locking mechanism may alternate between a locked position and an unlocked position. The locking mechanism may retain the door in the closed position while the locking mechanism may be in the locked position. The locking mechanism may allow the door to move to the open position while the locking mechanism may be in the unlocked position. The one or more sensors may determine whether the locking mechanism may be in a locked position. The encoder may be coupled with the motor and may determine a position of the motor. The controller may receive output from the encoder that may be indicative of the position of the motor to determine a position of the locking mechanism. The controller may verify the position of the locking mechanism as indicated by the output from the one or more sensors by using the output from the encoder.

In one embodiment, a method is provided that may include measuring one or more characteristics of a motor that may rotate a shaft that may move a door between an open position and a closed position. The method may include sensing a first position of a door locking mechanism at a first time. The door may be in a closed position at the first time. The method may include determining a second position of the door locking mechanism at the first time based at least in part on the one or more characteristics of the motor. The method may include comparing the first position and the second position of the door locking mechanism at the first time. The method may include taking a first action responsive to the first position and the second position differing at the first time. The method may include taking a second action responsive to the first position and the second position being the same at the first time.

### BRIEF DESCRIPTION OF THE DRAWINGS

The subject matter may be understood from reading the following description of non-limiting embodiments, with reference to the attached drawings, wherein below:

FIG. 1 shows an overview of a door actuation and locking system in an unlocked position, according to one example;

FIG. 2 shows the door actuation and locking system of FIG. 1 in a locked position, according to one example;

FIG. 3 shows a vehicle including doors, a door actuation, and locking system, shown with the doors in a closed position;

FIG. 4 shows a vehicle including doors, a door actuation, and locking system, shown with the doors in an open position; and

FIG. 5 shows a flow chart of a method of monitoring a door locking mechanism, according to one example.

### DETAILED DESCRIPTION

Examples of the subject matter described herein relate to a door position and door lock mechanism determination and verification system and method.

A door system may be driven by an actuation device, for example a motor rotating a motor shaft, that may move one or more doors between an open position and a closed position. A door locking mechanism may be movable between a locked position and an unlocked position. When the door locking mechanism is in the locked position, the door locking mechanism may retain the door in the closed position.

The door system may include a DL sensor, such as a switch, a proximity sensor, or the like, that may determine whether the door lock mechanism may be in the locked position. However, the primary sensor may fail. An additional sensor may be used as a backup or validation of the primary sensor, however, the additional sensor may add cost and complexity to the door system.

A secondary validation system and method may be implemented using components that may already be equipped in the door system. For example, the actuation device may be a motor equipped with a position sensor, for example an encoder. The encoder may be optical, mechanical, magnetic, resistive, or the like. The encoder may determine a rotary position of the actuation device, as well as monitor movement, moving speeds, directions, and the like of the actuation device. The rotary position of the actuation device may be correlated to the position of the doors and/or the position of the door lock mechanism.

While one or more embodiments are described in connection with a transit or rail vehicle system, other embodiments are not connected to transit or rail vehicle systems. Unless expressly disclaimed or stated otherwise, the subject matter described herein extends to automobiles, trucks (with or without trailers), buses, marine vessels, aircraft, unmanned aircraft (e.g., drones), mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

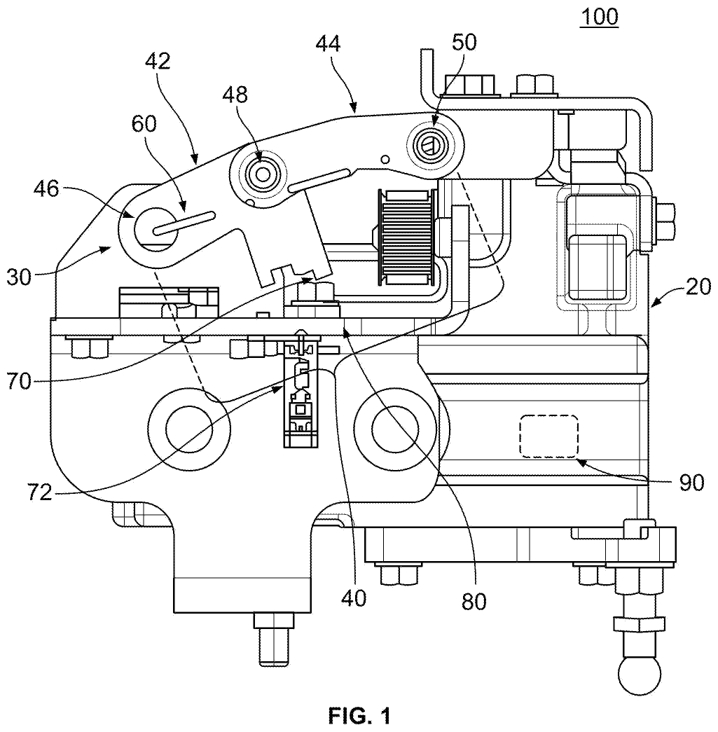

FIG. 1 illustrates an overview of a door actuation and locking system 100 in an unlocked position, according to one example. The system may be a door system, such as a single door or a dual panel door, including a first door panel and a second door panel. In other examples, the door system may include more than two door panels. The door panel(s) may be movable between an open position and a closed position. The door panel(s) may be on a vehicle, for example a bus, a train, an automobile, a maritime vehicle, or the like. The door may include a door carrier frame 20.

The door actuation system may include an actuation device 30. In one example, the actuation device may include a motor that rotates a motor shaft 46. In one example, the actuation device may include a rotary motor actuator, however in other examples, the actuation device may include a linear motor actuator, an electromechanical actuator, electrohydraulic actuator, a pneumatic actuator, or the like. In one example, the actuation device may include an electric motor, a stepper motor, a telescopic hydraulic cylinder, a pulley, or the like. The actuation device may provide controlled movements to, and positioning of, the door(s). The actuation device may act as a prime mover driving the door between the open and closed positions.

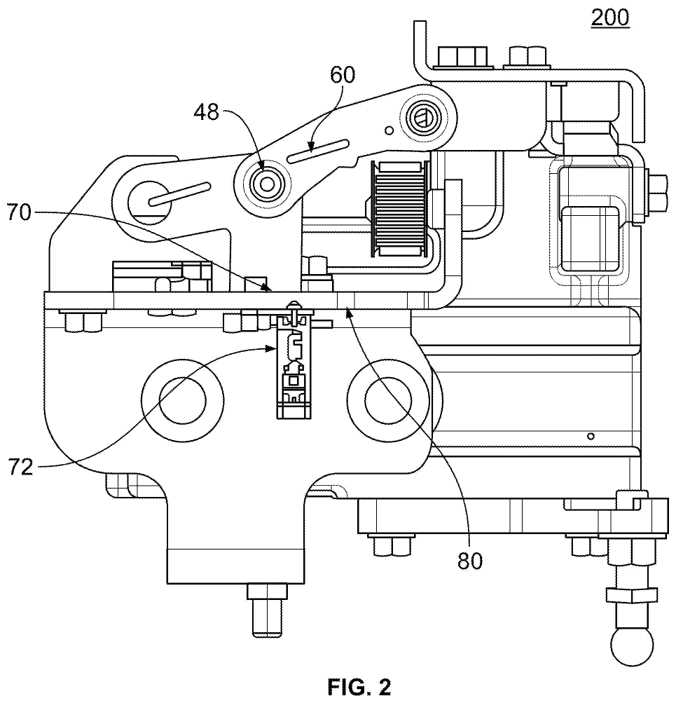

The system may include a locking mechanism 40. In one example, the locking mechanism may be an overcenter locking mechanism. The locking mechanism may be rotatable by the actuation device between an unlocked position (FIG. 1) and a locked position (FIG. 2). When the door is in the closed position, the locking mechanism may be in the locked position. The locked position of the locking mechanism may retain the door in the closed position. When the door is in the open position, the locking mechanism may be in the locked position, which may retain the door in the open position. When a door open signal or command may be sent by a controller 90 or an operator of the vehicle, the locking mechanism may be moved to the unlocked position. In the unlocked position, the locking mechanism may allow the movement of the door between the open position and the closed position, and vice versa.

The controller may be positioned within the door actuation system or may be positioned remotely from the door actuation system. The controller may include microcontrollers, processors, microprocessors, or other logic devices that operate based on instructions stored on a tangible and non-transitory computer readable storage medium, such as software applications stored on a memory.

If a system, apparatus, assembly, device, etc. (e.g., a controller, control device, control unit, etc.) includes multiple processors, these processors may be located in the same housing or enclosure (e.g., in the same device) or may be distributed among or between two or more housings or enclosures (e.g., in different devices). The multiple processors in the same or different devices may each perform the same functions described herein, or the multiple processors in the same or different devices may share performance of the functions described herein. For example, different processors may perform different sets or groups of the functions described herein.

The locking mechanism may include a motor link 42 and a driven link 44. The motor link may be a body connected on one end to the motor shaft and on the opposing end to a central joint 48. In one example, the motor link may be elongated and may extend linearly between the motor shaft and the central joint. In another embodiment, the motor link may be curved between the motor shaft and the central joint. In the embodiment illustrated in FIG. 1, the motor link may be substantially “L” shaped. The motor link may be substantially planar.

The driven link may be a body connected on one end to the central joint and on the opposing end to a point 50 on the door carrier frame. In one example, the drive link may be elongated and may extend linearly between the central joint and the point. In another example, the motor link may be curved between the central joint and the point. The driven link may be substantially planar. A center line 60 may be represented between the motor shaft and the point on the carrier frame. In the unlocked position, shown in FIG. 1, the central joint may be positioned above the center line and a compressive force (pushing to the left in FIG. 1) may push the central joint further above the centerline. The compressive force and push may allow free movement of the door. A clockwise torque on the motor link from the motor shaft may drive the carrier frame to the right and the central joint across the centerline (i.e., overcenter) to the locked position.

FIG. 2 illustrates the door actuation and locking system 200 as shown in FIG. 1, in a locked position, according to one example. In the locked position, a portion of the central joint may be positioned below the center line. A compressive force may be provided by the motor and may push the central joint downward against a stop 80 that may prevent further motion in a downward direction. The compressive force may ensure that the locking mechanism maintains the locked position.

The door actuation system may include one or more sensors. The sensors may include electrical sensors or mechanical sensors. The electrical sensors may include an ohmmeter measuring electrical resistance, a voltmeter measuring electrical potential in volts, an impedance analyzer measuring impedance, an ammeter measuring current, a database or memory, an input device (e.g., control panel, switch, keyboard, etc.), or the like. The electrical sensors may read the electrical characteristics of components of the door actuation system, for example the actuation device. The mechanical sensor may include an optical sensor (e.g., an infrared sensor, a proximity detector), an acoustic sensor (e.g., an ultrasonic sensor), a capacitive sensor, a photoelectric sensor, an inductive sensor, a laser distance sensor (e.g., Light Detection and Ranging [“LIDAR”]), an encoder, or the like. The mechanical sensors may measure physical characteristics components of the actuation device or the environment around the actuation device or the door.

A DL sensor may determine whether the locking mechanism is in the locked position. In one example, the DL sensor may be a proximity sensor. In another example, the DL sensor may be a switch 72 that may be engaged by a protrusion 70 when the locking mechanism is in the locked position. The protrusion may be positioned on the motor link. The switch may be positioned on the stop. In another example, the protrusion may be mounted on the driven link or elsewhere on the locking mechanism or the actuation device. The engagement of the protrusion with the switch may provide the door locked signal to the controller, indicating that the locking mechanism is in the locked position.

A counterclockwise rotation of the motor shaft may drive the central joint toward the center line and may push against, and overcome, the compressive force. This motion may move the locking mechanism to the unlocked position, which may allow the door to move between the open and closed positions. In the unlocked position, the protrusion may be spaced apart from the switch, as shown in FIG. 1. When the protrusion may be spaced from the switch, a door unlocked signal may be sent to the controller. The DL sensor may communicate the signal indicative of the position of the locking mechanism to the controller.

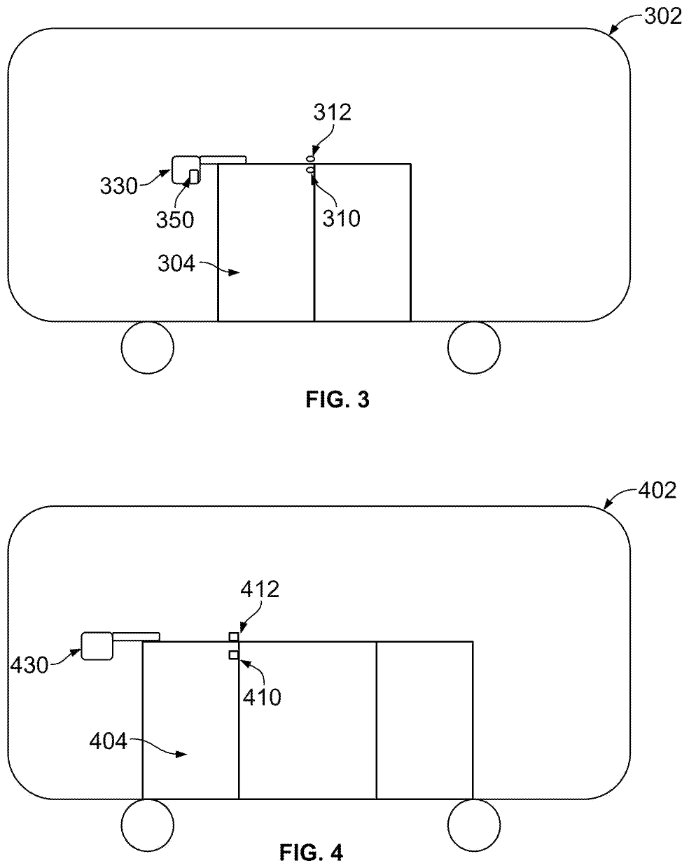

FIG. 3 illustrates a vehicle 302 including doors 304 with a door actuation and locking system, where the doors are in the closed position, according to one example. The doors may be moved between the open and closed positions by a motor 330 or an actuation device. In one example, the door actuation system may include a door fully closed (DFC) position sensor 310. The DFC position sensor may be positioned adjacent to the door, such that the DFC position sensor may be able to determine a movement and/or a position of the door. The DFC position sensor may be positioned to sense a target 312 connected to the door. In one example, the DFC position sensor may be on the door and the target may be positioned adjacent the door. The target may be read by the DFC position sensor and may indicate when the door may be in the fully closed position. The DFC position sensor may communicate with the controller to indicate when the door is in the fully closed position. Additionally, the DFC position sensor may determine a change in position of the doors and the DFC position sensor may communicate the change to the controller.

FIG. 4 illustrates a vehicle 402 including doors 404, a door actuation, and locking system, where the doors are in the open position, according to one example. The doors may be moved between the open and closed positions by a motor 430 or an actuation device. In one example, the door actuation system may include a door fully open (DFO) position sensor 410. The DFO position sensor may interact with a target 412 to determine when the door may be in the fully open position. The DFO position sensor may be positioned on the door and the target may be positioned adjacent the door. In one example, the DFC position sensor may be positioned adjacent the door and the target may be positioned on the door.

As discussed above, the actuation device may include the motor and motor shaft. The motor may rotate the motor shaft to drive the doors between the open position and the closed position. The motor shaft of the motor may have a different position based on whether the door is in the open position, the closed position, or an intermediate position between the open position and the closed position. Once the doors reach the open position or the closed position, the motor may provide a further rotation to apply a torque to drive the locking mechanism into the locked position. The motor shaft may have a different position based on whether the locking mechanism may be in the unlocked position or the locked position. For example, in moving between the unlocked and locked positions, the position of the motor shaft may change by a predetermined number of revolutions. For example, the motor shaft may rotate the predetermined number of revolutions to move from the unlocked position to the locked position. The encoder may be able to measure the number of revolutions and may determine the locking state of the locking mechanism based on the measured number of revolutions. The motor shaft may have a different position in the unlocked position and the locked position. For example, the motor shaft may be at zero degrees in the unlocked position and may be at 180 degrees in the locked position. The position may vary based on the characteristics of the specific door, but in any event, the motor shaft may be in a different position in the unlocked position and in the locked position.

The actuation device may include a position sensor that may measure one or more characteristics of the actuation device or a component of the actuation device. In one example, the position sensor may be an encoder 350 that may sense a rotation of the motor shaft relative to a motor body. The encoder may be shown in FIG. 3. The encoder may sense the relative motion of the motor shaft and output an electrical signal to the controller. The encoder may include one or more transducers that may generate electronic signals as the motor shaft moves. In one example, the encoder may be an absolute encoder that may sense the position of the motor shaft directly. In another example, the encoder may be an incremental encoder that may sense the motion, the speed, and the direction of rotation of the motor shaft. The controller may be able to determine the position of the motor shaft based on the sensed motion, speed, and or direction of rotation of the motor shaft. The encoder may output a reading or signal of the motion, speed, and/or direction of rotation of the motor shaft to the controller of the system. The encoder may output a series of high and low electrical signals that may correspond to a particular degree of rotation of the motor shaft. The low electrical signals may be associated with a particular range of degree of rotation of the motor shaft, for example a lower range. The high electrical signals may be associated with a particular range of degree of rotation of the motor shaft, for example an upper range.

The encoder may have different levels of resolution. Encoder resolution may be the number of measuring segments or units in one revolution of an encoder shaft. Encoder resolution may be measured in pulses per revolution (PPR) for incremental encoders and may be measured in bits for absolute encoders. In one example, the encoder may have a resolution of 1095 PPR and so each pulse may correspond to 0.33 degrees of motor shaft revolution. In another example, the encoder may have a resolution of between 2000 PPR and 30,000 PPR. The controller may receive the outputs from the encoder and may infer or determine a position of the motor shaft. The controller may track the number of pulses. The number of pulses may be referred to as the encoder count.

At various times, the controller may collect and record values output from the one or more sensors to improve the determination and validation of the locking mechanism position. During installation and setup of the door actuation system, the controller may collect and record data values output from the one or more sensors, for example the DL sensor, the DFC position sensor, the DFO position sensor, and the encoder. The data values may be output while the door may be cycled through a specified number of cycles of opening and closing the door panels and/or locking and unlocking the locking mechanism. The outputs may be recorded and averaged to determine a predetermined range and/or tolerance that may be expected when the door is in the open position, the door is in the closed position, the locking mechanism is in the unlocked position, and the locking mechanism is in the locked position, respectively. Additionally, the controller may collect and record data values output from the encoder indicating the speed of the motor shaft when the locking mechanism may be entering the locked position. The controller may determine a range and/or tolerance for the speed of the motor shaft entering the locked position.

A computational model may be used for simulating the behavior of the door and/or the locking mechanism. The model may provide a comparison for the open position of the door, the closed position of the door, the unlocked position of the locking mechanism, and/or the locked position locking mechanism. These positions may not need to be assumed to be fixed at a constant value, but rather may be adjusted in the course of degradation of the door and/or the locking mechanism. The adjustment of the model may be expressed in particular in a modification of the predictions of the model. The values processed by the model may be compared with reference values or thresholds, which may not be fixed but rather may be correspondingly adjusted in the course of the determined degradation of the door and/or locking mechanism. The model may be able to determine a gradual drift or deviation in the values associated with the positions (e.g., unlocked/locked position of the locking mechanism) and may implement modifications or inspections based on the gradual drift or deviation.

The controller may receive the encoder count value responsive to the DL sensor being activated and indicating a locked position. The controller may determine the encoder count value or range that may be associated with the locked position of the locking mechanism based on the collected and recorded data values. The controller may then use the encoder count value to validate or contradict the DL sensor locked position output.

The controller may receive a distance in encoder counts between when the DFC position sensor is activated, indicating the door is closed, and the DL sensor is activated, indicating the locking mechanism is locked. The controller may determine distance or distance range in the encoder counts between these signals that may be associated with the locked position of the locking mechanism based on the collected and recorded data values. The controller may validate or contradict the DL sensor locked position output based on this determination.

In another example, the controller may receive an upper encoder speed measured between when the DFC position sensor is activated, indicating the door is closed, and the DL sensor is activated, indicating the locking mechanism is locked. The controller may determine the upper encoder speed or range of speed between these signals that may be associated with the locked position of the locking mechanism based on the collected and recorded data values. The controller may validate or contradict the DL sensor locked position output based on this determination.

The controller may receive one or more of the above listed outputs. The more outputs used by the controller and compared to the recorded and averaged data may result in more accurate and more precise determinations by the controller of the status of the locking mechanism.

During operation of the door actuation system, the output values may be received by the controller, and the controller may compare the measured outputs with a stored running average of outputs where the locking mechanism may be operational in the locked position. The controller may output a validation: the DL sensor state may be confirmed or contradicted. The DL sensor may be confirmed where position of the locking mechanism determined by the controller using the output from the encoder is the same or is within a predetermined range of the determination of the position of the locking mechanism from the DL sensor. Alternatively, where the determined position of the locking mechanism by the outputs from the encoder and the DL sensor are different or outside the predetermined range, the DL sensor may be contradicted. The controller output may indicate a fault condition to an operator or an off-board controller that may indicate that the door may need inspection and/or repair. However, while the determination of the position of the locking mechanism by the encoder and the DL sensor may be discussed in tandem above, the determination of each may be used independently of one another, without confirming or contradicting the other determination.

The controller may use the outputs received from one or more sensors to determine one or more characteristics about the system. The controller may compare the outputs from the different sensors (e.g., the DL sensor, the DFC position sensor, the DFO position sensor, the encoder) to confirm or validate the determination of the door and/or the locking mechanism status. The controller may determine whether the outputs of the sensors are within a predetermined range indicative of a functional locking position or a functional unlocking position. For example, the controller may determine that the encoder speed between when the DFC position sensor is activated and the DL sensor is activated may be below the predetermined range. Thus, the controller may determine that, while the actuation device may still be operable to lock the locking mechanism, the actuation device may need inspection.

In another example, the controller may determine that the distance in encoder counts between when the DFC position sensor is activated, and the DL sensor is activated may be outside of the predetermined range. If the outputs may be outside the predetermined range, the controller may take or implement a responsive action. The responsive action may include adjusting or stopping the operation of the actuation device, generating an alert, sending a notification to an output device of the vehicle to notify an operator, requesting an inspection of the door system by sending a signal to the operator or another controller, moving the door to the closed position by controlling the door actuation device, or the like. The alerts, notifications, and requests may be communicated by the controller using a communication device. The communication device may communicate with one or more other systems and/or other remote locations. The communication device may include or represent an antenna (along with associated transceiver hardware circuitry and/or software applications) for wirelessly communicating with other vehicle systems and/or remote locations.

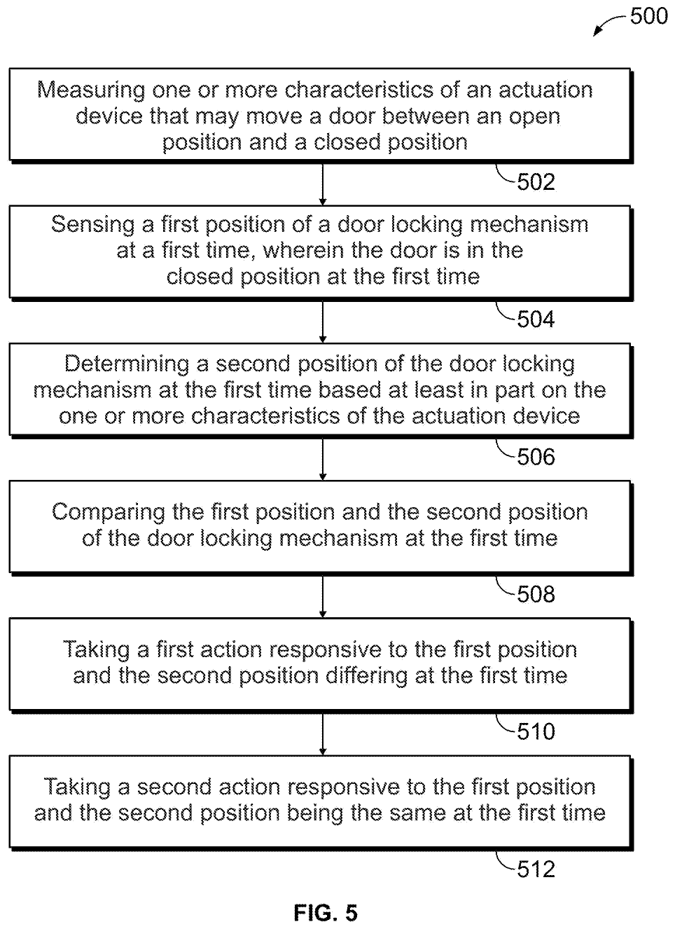

FIG. 5 illustrates a flow chart of a method of monitoring door actuation 500, according to one example. At step 502, the method may include measuring one or more characteristics of a motor that may rotate a shaft. The motor may move a door between an open position and a closed position. The one or more characteristics may include one or more of a position, a speed, or a direction of the actuation device.

At step 504, the method may include sensing a first position of a door locking mechanism at a first time. The door may be in the closed position at the first time. The first position of the door locking mechanism may be measured using a proximity sensor. In one example, the proximity sensor may be a switch.

At step 506, the method may include determining a second position of the door locking mechanism at the first time based at least in part on the one or more characteristics of the motor. The second position of the door locking mechanism may be determined using a sensor in the motor. In one example, the second position may be determined by using an encoder.

At step 508, the method may include comparing the first position and the second position of the door locking mechanism at the first time. In one example, a controller may be used to compare the first position and the second position of the door locking mechanism.

At step 510, the method may include taking a first action responsive to the first position and the second position differing at the first time. The first position and the second position differing may indicate an issue or a fault with one or more of the motor, the door, the door locking mechanism, the sensor, or the encoder. In one example, the first action may include one or more of sending a notification, requesting an inspection, or moving the door to the closed position.

At step 512, the method may include taking a second action responsive to the first position and the second position being the same at the first time. The first position and the second position being the same may validate the readings of the first position and the second position, respectively. Said another way, the first and second positions being aligned may indicate that the locking mechanism may be operating properly and may be in the locked position.

In one embodiment, a system is provided that may include a motor, a locking mechanism, an encoder, and a controller. The motor may rotate a shaft to move a door between an open position and a closed position. The locking mechanism may alternate between a locked position and an unlocked position. The locking mechanism may retain the door in the closed position responsive to the locking mechanism being in the locked position. The locking mechanism may allow the door to move to the open position responsive to the locking mechanism being in the unlocked position. The encoder may be coupled with the motor and may determine one or more of movement, a speed, or a direction the motor moves. The controller may receive output from the encoder that may indicate the one or more of the movement, the speed, or the direction the motor moves to determine a position of the locking mechanism.

In one example, the system may include one or more redundant sensors that may determine whether the locking mechanism may be in the locked position or the unlocked position. The controller may determine or verify the position of the locking mechanism based on output from the one or more redundant sensors. The controller may verify the position of the locking mechanism as indicated by the output from the encoder using the output from the one or more redundant sensors.

In one example, the controller may generate an alert responsive to the output from the encoder and the output from the one or more redundant sensors being different. The system may include one or more door sensors that may determine whether the door is in the open position or the closed position responsive to the locking mechanism being in the locked position. The locking mechanism may include an overcenter lock mechanism. The controller may determine the position of the overcenter lock mechanism as one or more of overcenter of a center line or undercenter of the center line.

The controller may initiate an inspection of the locking mechanism responsive to the one or more the movement, the speed, or the direction at which the motor moves being outside a predetermined range. The controller may move the door to the closed position responsive to the output from the encoder and the output from the one or more redundant sensors being different

In one embodiment, a system is provided that may include a motor, a locking mechanism, one or more sensors, an encoder, and a controller. The motor may rotate a shaft to move a door between an open position and a closed position. The locking mechanism may alternate between a locked position and an unlocked position. The locking mechanism may retain the door in the closed position while the locking mechanism may be in the locked position. The locking mechanism may allow the door to move to the open position while the locking mechanism may be in the unlocked position. The one or more sensors may determine whether the locking mechanism may be in a locked position. The encoder may be coupled with the motor and may determine a position of the motor. The controller may receive output from the encoder that may indicate the position of the motor to determine a position of the locking mechanism. The controller may verify the position of the locking mechanism as indicated by the output from the one or more sensors by using the output from the encoder.

In one example, the controller may verify the position of the locking mechanism as indicated by the output of the encoder by using the output from the one or more sensors. The controller may compare the output from the encoder with a predetermined expected range. The controller may generate an alert responsive to the output from the encoder being outside the predetermined expected range.

The controller may generate an alert responsive to the output from the encoder and the output from the one or more sensors providing a different position of the locking mechanism. The system may include one or more sensors that may determine whether the door is in the open position or the closed position responsive to the locking mechanism being in the locked position.

The locking mechanism may include an overcenter lock mechanism. The controller may determine the position of the overcenter lock mechanism as one or more of overcenter of a center line or undercenter of the center line. The controller may initiate an inspection of the locking mechanism responsive to the position of the motor being outside a predetermined range.

In one embodiment, a method may include measuring one or more characteristics of a motor that may rotate a shaft to that may move a door between an open position and a closed position. The method may include sensing a first position of a door locking mechanism at a first time. The door may be in a closed position at the first time. The method may include determining a second position of the door locking mechanism at the first time based at least in part on the one or more characteristics of the motor. The method may include comparing the first position and the second position of the door locking mechanism at the first time. The method may include taking a first action responsive to the first position and the second position differing at the first time. The method may include taking a second action responsive to the first position and the second position being the same at the first time.

The one or more characteristics of the motor may include one or more of a relative motion, a speed, or a direction of the actuation device. In one example, the first action may include one or more of sending a notification, requesting an inspection, or moving the door to the closed position.

The method may include determining a third position of the door locking mechanism at a second time based at least in part on the one or more characteristics of the actuation device. The door may be in the closed position at the second time. The method may include taking a third action responsive to the third position and the second position differing by more than a predetermined threshold. The method may include taking a fourth action responsive to the one or more characteristics of the motor being outside a predetermined range.

In one embodiment, the system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the system may include a policy engine that may apply one or more policies. These policies may be based at least in part on characteristics of a given item of equipment or environment. With respect to control policies, a neural network can receive input of a number of environmental and task-related parameters. These parameters may include an identification of a determined locked position for the locking mechanism, data from various sensors, and location and/or position data. The neural network can be trained to generate an output based on these inputs, with the output representing an action or sequence of actions that the locking mechanism, motor, and controller should take to accomplish the locked position. During operation of one embodiment, a determination can occur by processing the inputs through the parameters of the neural network to generate a value at the output node designating that action as the desired action. This action may translate into a signal that causes the locking mechanism to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., a position, speed, or direction of the motor shaft), use a model that associates inputs with different operating modes to select an operating mode of the one or more functional locking mechanisms, and then provide an output (e.g., the operating mode of the locking mechanism, the motor, and the controller, selected using the model). The controller may receive additional input of the change in operating mode that was selected, such as analysis of noise or interference in communication signals (or a lack thereof), operator input, or the like, that indicates whether the machine-selected operating mode provided a desirable outcome or not. Based on this additional input, the controller can change the model, such as by changing which operating mode would be selected when a similar or identical input or change in input is received the next time or iteration. The controller can then use the changed or updated model again to select an operating mode, receive feedback on the selected operating mode, change or update the model again, etc., in additional iterations to repeatedly improve or change the model using artificial intelligence or machine learning.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended claims, along with the full scope of equivalents to which such claims are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system, comprising:
a motor configured to rotate a shaft to move a door between an open position and a closed position;
a locking mechanism configured to alternate between a locked position and an unlocked position, wherein the locking mechanism is configured to retain the door in the closed position responsive to the locking mechanism being in the locked position and the locking mechanism is configured to allow the door to move to the open position responsive to the locking mechanism being in the unlocked position;
an encoder configured to be coupled with the motor and determine one or more of movement, a speed, or a direction the motor moves; and
a controller configured to receive output from the encoder indicative of the one or more of the movement, the speed, or the direction the motor moves to determine a position of the locking mechanism.

2. The system of claim 1, further comprising one or more redundant sensors configured to determine whether the locking mechanism is in the locked position or the unlocked position, the controller configured to determine or verify the position of the locking mechanism based on output from the one or more redundant sensors.

3. The system of claim 2, wherein the controller is configured to verify the position of the locking mechanism indicated by the output from the encoder using the output from the one or more redundant sensors.

4. The system of claim 3, wherein the controller is configured to generate an alert responsive to the output from the encoder and the output from the one or more redundant sensors being different.

5. The system of claim 1, further comprising one or more door sensors configured to determine whether the door is in the open position or the closed position responsive to the locking mechanism being in the locked position.

6. The system of claim 1, wherein the locking mechanism includes an overcenter lock mechanism and the controller is configured to determine the position of the overcenter lock mechanism as one or more of overcenter of a center line or undercenter of the center line.

7. The system of claim 1, wherein the controller is configured to initiate an inspection of the locking mechanism responsive to the one or more the movement, the speed, or the direction at which the motor moves being outside a predetermined range.

8. The system of claim 1, wherein the controller is configured to move the door to the closed position responsive to the output from the encoder and the output from the one or more redundant sensors being different.

9. A system, comprising:
a motor configured to rotate a shaft to move a door between an open position and a closed position;
a locking mechanism configured to alternate between a locked position and an unlocked position, wherein the locking mechanism is configured to retain the door in the closed position responsive to the locking mechanism being in the locked position and the locking mechanism is configured to allow the door to move to the open position responsive to the locking mechanism being in the unlocked position;
one or more sensors configured to determine whether the locking mechanism is in the locked position or the unlocked position;
an encoder coupled with the motor and configured to determine a position of the motor; and
a controller configured to receive output from the encoder indicative of the position of the motor to determine a position of the locking mechanism,
wherein the controller is configured to verify the position of the locking mechanism as indicated by the output from the one or more sensors using the output from the encoder.

10. The system of claim 9, wherein the controller is configured to verify the position of the locking mechanism as indicated by the output of the encoder using the output from the one or more sensors.

11. The system of claim 10, wherein the controller is configured to compare the output from the encoder with a predetermined expected range, wherein the controller is configured to generate an alert responsive to the output from the encoder being outside the predetermined expected range.

12. The system of claim 11, wherein the controller is configured to generate an alert responsive to the output from the encoder and the output from the one or more sensors providing different positions of the locking mechanism.

13. The system of claim 9, further comprising one or more sensors configured to determine whether the door is in the open position or the closed position responsive to the locking mechanism being in the locked position.

14. The system of claim 9, wherein the locking mechanism includes an overcenter lock mechanism and the controller is configured to determine the position of the overcenter lock mechanism as one or more of overcenter of a center line or undercenter of the center line.

15. The system of claim 9, wherein the controller is configured to initiate an inspection of the locking mechanism responsive to the position of the motor being outside a predetermined range.

16. A method, comprising:
measuring one or more characteristics of a motor configured to rotate a shaft to move a door between an open position and a closed position;
sensing a first position of a door locking mechanism at a first time, wherein the door is in the closed position at the first time;
determining a second position of the door locking mechanism at the first time based at least in part on the one or more characteristics of the motor;
comparing the first position and the second position of the door locking mechanism at the first time;
taking a first action responsive to the first position and the second position differing at the first time;
taking a second action responsive to the first position and the second position being the same at the first time.

17. The method of claim 16, wherein the one or more characteristics include one or more of a relative motion, a speed, or a direction of the motor.

18. The method of claim 16, wherein the first action includes one or more of sending a notification, requesting an inspection, or moving the door to the closed position.

19. The method of claim 16, further comprising determining a third position of the door locking mechanism at a second time based at least in part on the one or more characteristics of the motor, wherein the door is in the closed position at the second time, and
taking the first action responsive to the third position and the second position differing by more than a predetermined threshold.

20. The method of claim 16, further comprising taking the first action responsive to the one or more characteristics of the actuation device being outside a predetermined range.
